(19) United States
(12) Patent Application Publication
(10) Pub. No.: US 2005/0030584 A1
(43) Pub. Date: Feb. 10, 2005

(54) Print system

(76) Inventor: Hiroshi Tanaka, Asaka-shi (JP)

Correspondence Address: BIRCH STEWART KOLASCH & BIRCH, PO BOX 747, FALLS CHURCH, VA, 22040-0747, US

(21) Appl. No.: 10/909,362

(22) Filed: Aug. 3, 2004

(30) Foreign Application Priority Data
Aug. 4, 2003 (JP) 2003-286066

(51) Int. Cl. G06F 15/00; H04N 1/23

(52) U.S. Cl. 358/1.16; 358/1.15; 358/302

(57) ABSTRACT

A user selects one of a plurality of images stored in a recording medium in a storage which is to be printed using a user interface of a camera. Then, the camera issues a print request containing an image identifier for the selected image. A transfer device (bridge) of the storage connected to the camera transfers the print request directly to a printer. Then, on the basis of the image identifier in the print request, the printer acquires the image to be printed, from the storage, and then prints this image. Alternatively, the camera, the printer, and the storage may be connected in this order, and the printer may be provided with the transfer device that transfers a request and a response directly between the camera and the storage.

### BACKGROUND OF THE INVENTION

1. Field of the Invention

The present invention relates to a print system and its storage and printer, and in particular, to a print system which transfers an image from a storage directly to a printer via a predetermined communication path for printing, as well as a storage and printer for the print system.

2. Description of the Related Art

A camera with a removable memory card has been proposed. With this camera, photographed images are read from a memory card and displayed by user operation in the order of photographing. Then, while viewing the displayed images, the user performs a print setting operation, that is, sets the number of printed sheets, whether or not print is required, and the like. The contents of the settings in the memory card are then stored in the memory card as print control information (see, for example, Japanese Patent Application Publication No. 11-355704). To print the images, the user removes the memory card from the camera and then installs it in a printer. Then, the printer reads the images and print control information corresponding to each image to print the images in accordance with the print control information.

Another camera with a removable memory card has been proposed. To print images, the camera reads them from the memory card and converts them into data printable by the printer. Then, the camera outputs the resulting data directly to the printer (see, for example, Japanese Patent Application Publication No. 11-355704).

Another system has been proposed in which images are saved to a hard disk provided in a server computer and are printed in accordance with instructions given by the user to the camera (see, for example, Japanese Patent Application Publication No. 2000-350136).

### SUMMARY OF THE INVENTION

A problem with the memory card is that it is expensive compared to photographing films for silver salt cameras, so that a large number of images each requiring a large capacity cannot be saved to the memory card.

On the other hand, a print system has been desired which does not use any server computer.

In this regard, Japanese Patent Application Publication No. 2000-350136 describes a specific configuration to indicate how a user interface of the camera is used to choose from images temporarily saved by the camera to the server computer and how the selected image is transferred from the server computer to the printer to execute printing.

In view of these circumstances, it is an object of the present invention to provide a print system that can directly transfer an image from a storage not having a user interface capable of displaying images to a printer not having a user interface capable of displaying images, via a predetermined communication path for printing.

To accomplish this object, a first aspect of the present invention provides a print system, comprising a printer, a storage, being connected to the printer via a first connection path, which takes each image out of a predetermined recording medium in which a plurality of images are recorded, and an operation apparatus connected to the storage via a second communication path, wherein the operation apparatus has a first storage client which acquires, from the storage, the images in the recording medium and image identifiers applied to the respective images, a user interface which displays images and which selectively manipulates an image to be printed, and a print client which issues a print request containing an image identifier corresponding to the image selected by the user interface, the storage has a first storage server which provides the operation apparatus with the images in the recording medium and the image identifiers applied to the respective images, a transfer device which transfers a print request from the operation apparatus directly to the printer, and a second storage server which provides the printer with an image corresponding an image identifier in the print request, the first storage server and the second storage server use the same image identifier for the same image, and the printer has a print server which receives the print request via the transfer device of the storage, a second storage client which acquires an image corresponding to the image identifier in the print request, from the storage, and a printing device which prints the image acquired from the storage.

With this configuration, the operation apparatus acquires the images in the recording medium and the image identifiers applied to the respective images and the user selects a desired image to be printed using the user interface of the operation apparatus. Then, the transfer device of the storage transfers the print request containing the image identifier for the image selected by the user, from the operation apparatus directly to the printer. Then, on the basis of the image identifier in the print request, the printer acquires the image to be printed, from the storage. The printer then prints the user's desired image.

A second aspect of the present invention provides a print system, comprising a printer, a storage, being connected to the printer via a first connection path, which takes each image out of a predetermined recording medium in which a plurality of images are recorded, and an operation apparatus connected to the storage via a second communication path, wherein the operation apparatus has a first storage client which requests acquires, from the storage, the images in the recording medium and image identifiers applied to the respective images, a user interface which displays images and which selectively manipulates an image to be printed, and a print client which issues a print request containing an image identifier corresponding to the image selected by the user interface, the storage has a first storage server which provides the operation apparatus with the images in the recording medium and the image identifiers applied to the respective images, and a second storage server which provides the printer with an image corresponding an image identifier in the print request, the first storage server and the second storage server use the same image identifier for the same image, and the printer has a transfer device which directly transfers a request from the operation apparatus to the storage and a response from the storage to the operation apparatus, a print server which receives a print request from the operation apparatus, a second storage client which acquires an image corresponding to the image identifier in the print request, from the storage, and a printing device which prints the image acquired from the storage.

With this configuration, the transfer device of the printer transfers a request from the operation apparatus directly to the storage and a response from the storage directly to the operation apparatus. Thus, when the operation apparatus acquires the images in the recording medium and the image identifiers applied to the respective images and the user selects the desired image to be printed using the user interface of the operation apparatus, the operation apparatus outputs the print request containing the image identifier for the image selected by the user, to the printer. On the basis of the image identifier in the print request, the printer acquires the image to be printed, from the storage. The printer then prints the user's desired image.

A third aspect of the present invention is the first or second aspect, wherein the first storage server provides the operation equipment with contracted images for display which are obtained by contracting the images recorded in the recording medium and which are displayed by the user interface of the operation equipment so that the contracted images are displayed by the user interface of the operation apparatus.

This arrangement allows the storage to provide the contracted images to the operation apparatus. Therefore, images to be displayed are efficiently transmitted and received.

Here, for the contracted images, if an image file contains not only images but also thumbnail images, the thumbnail images may be taken out of the image file and then provided to the operation apparatus. Alternatively, the contracted images may be generated by reducing the display size of the images (original images) in the image file.

A fourth aspect of the present invention provides a storage, comprising a first connector connected to an operation apparatus having a user interface which displays images and which selectively manipulates an image to be printed, a second connector connected to a printer which prints images, a first storage server which provides the operation apparatus, via the first connector, with the images in a predetermined recording medium in which a plurality of images are recorded and image identifiers applied to the respective images, a transfer device which operates upon receiving a print request containing an image identifier corresponding to the image selected by the user interface of the operation apparatus via the first connector from the operation apparatus, to transfer the print request directly to the printer via the second connector, and a second storage server which operates upon receiving an image request containing the image identifier in the print request, from the printer via the second connector, to provide the printer with an image corresponding the image identifier via the second connector, wherein the first storage server and the second storage server use the same image identifier for the same image.

A fifth aspect of the present invention provides a printer, comprising a first connector connected to a storage which takes each image out of a predetermined recording medium in which a plurality of images are recorded, a second connector connected to an operation apparatus having a user interface which displays images and which selectively manipulates an image to be printed, a transfer device which operates upon receiving the images in the recording medium and image identifiers applied to the respective images, from the storage via the first connector, to transfer the image and image identifier directly to the operation apparatus via the second connector, a print server which receives a print request containing an image identifier corresponding to the image selected by the user interface of the operation apparatus, from the operation apparatus via the second connector, a storage client which acquires an image corresponding to the image identifier in the print request, from the storage via the first connector, and a printing device which prints the image acquired from the storage.

According to the present invention an image from a storage not having a user interface capable of displaying images can be directly transferred to a printer not having a user interface capable of displaying images via a predetermined communication path for printing.

### BRIEF DESCRIPTION OF THE DRAWINGS

FIG. 1 is a schematic diagram showing a print system according to a first embodiment of the present invention;

FIG. 2 is a schematic block diagram showing the internal configuration of the print system according to the first embodiment of the present invention;

FIG. 3 is a diagram showing the appearance of a camera;

FIG. 4 is a first flow chart illustrating operations of the print system according to the first embodiment;

FIG. 5 is a second flow chart illustrating operations of the print system according to the first embodiment;

FIG. 6 is a diagram illustrating an example of an image list;

FIG. 7 is a schematic diagram showing a print system according to a second embodiment of the present invention;

FIG. 8 is a schematic block diagram showing the internal configuration of the print system according to the second embodiment of the present invention;

FIG. 9 is a first flow chart illustrating operations of the print system according to the second embodiment; and

FIG. 10 is a second flow chart illustrating operations of the print system according to the second embodiment.

### DETAILED DESCRIPTION OF THE PREFERRED EMBODIMENTS

Preferred embodiments of the present invention will be described below with the accompanying drawings.

### First Embodiment

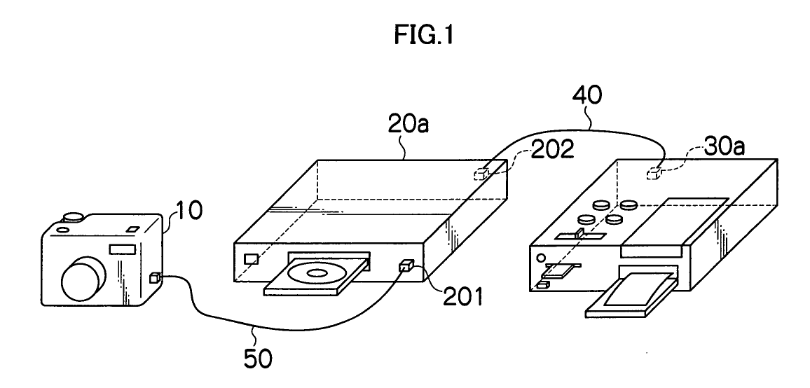

FIG. 1 is a schematic view of a print system according to a first embodiment of the present invention.

In the print system according to the first embodiment, a storage 20a and a printer 30a are connected using a first USB cable 40. Moreover, a camera 10 is connected to the storage 20a using a second USB cable 50. Here, the storage 20a and the printer 30a are connected together so that the storage 20a acts as a function (client), while the printer 30a acts as a host. The camera 10 and the storage 20a are connected together so that the camera 10 acts as a function (client), while the storage 20a acts as a host.

A connector 201 of the storage 20a is used to connect the storage 20a to the camera 10, which is a portable apparatus. The connector 201 is frequently inserted and removed by a user and is thus placed on a front surface of the body. On the other hand, a connector 202 is used to connect the storage 20a to the printer 30a, which is an installed apparatus. The connector 202 is not frequently inserted or removed by the user. Accordingly, the connector 202 is placed on a rear surface of the body so that the USB cable 40 does not obstruct operations.

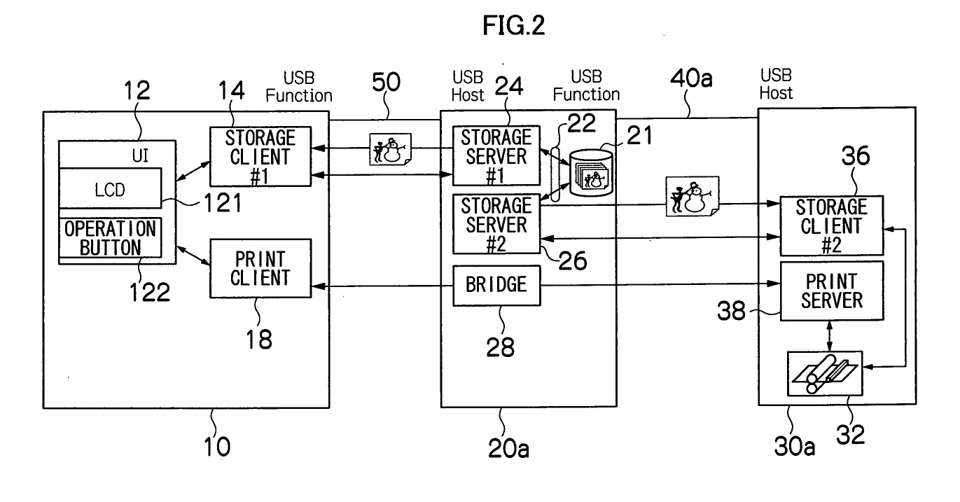

FIG. 2 is a block diagram showing the internal configuration of each of the camera 10, storage 20a, and printer 30a.

The camera 10 comprises a user interface 12 comprises a liquid crystal display (LCD) 121 and various operation buttons 122, a first storage client 14 that acquires, from the storage 20a, images in a recording medium 21 and image handles (also called image identifiers) applied to the respective images, and a print client 18 that issues a print request containing the image handle corresponding to an image to be printed.

The storage 20a comprises the removable recording medium 21 (for example, a CD-R, an MO, or a DVD-R), a recording medium controller 22 that, for example, writes or reads images in or from the recording medium 21, a first storage server 24 that provides the camera 10 with the images in the recording medium 21 and the mage handles applied to the respective images, a second storage server 26 that provides printed image data to the printer 30a on the basis of the image handle, and a bridge 28 that transfers a request from the camera 10 directly to the printer 30a and a response and an event notification from the printer 30a directly to the camera 10. The same recording medium controller 22 manages the image identifiers (image handles) for the images. Accordingly, the first storage server 24 and the second storage server 26 use the same image identifier for the same image.

The printer 30a comprises a print server 38 that receives a print request, a second storage client 36 that acquires the image corresponding to the image handler in the print request, from the storage 20a, and a print engine 32 that prints the image acquired from the storage 20a.

The first storage client 14 of the camera 10 and the first storage server 24 of the storage 20a constitute a pair. Specifically, the first storage client 14 requests an image list, a list of the images recorded in the recording medium 21, of the first storage server 24. Then, in response, the first storage server 24 provides the image list to the first storage client 14. The image list contains image handles. Further, the first storage client 14 requests image data to be displayed on the user interface 12, of the first storage server 24. Then, in response, the first storage server 24 provides the first storage client 14 with the image data to be displayed. The first storage client 14 specifies the image data to be displayed, using the image handle.

Further, the second storage client 36 of the printer 30a and the second storage server 26 of the storage 20a constitute a pair. Specifically, the second storage client 36 requests image data to be printed by the print engine 32, of the second storage server 26. Then, in response, the second storage server 26 provides the second storage client 36 with the printed image data. The second storage client 36 specifies the image data using the image handle.

The first storage server 24 and the second storage server 26 use the same image handle for the same image (the same image even after resizing).

Further, the print client 18 of the camera 10 and the print server 38 of the printer 30a constitute a pair. Specifically, the print client 18 issues a print request to the print server 38. Then, in response, the print server 38 uses the print engine 32 to print image data in accordance with the print request from the print client 18. The print client 18 specifies the image data using the image handle.

The bridge 28 of the storage 20a transfers a request from the print client 18 of the camera 10 directly to the print server 38 of the printer 30a and a response and an event notification from the print server 38 of the printer 30a directly to the print client 18 of the camera 10.

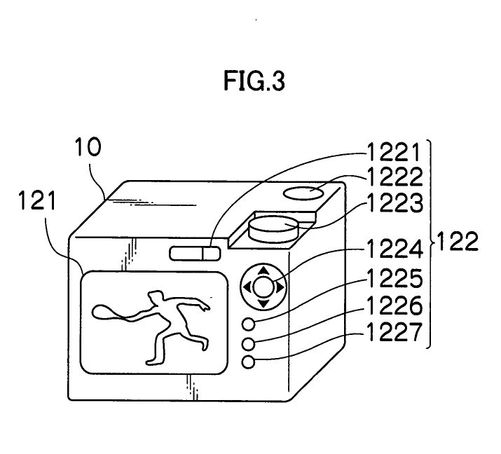

As shown in FIG. 3, the following components are arranged on the body of the camera 10 as the user interface 12: the liquid crystal display 121 that displays images, as well as operation buttons 122 including a power switch 1221, a release button 1222 used to input a photographing instruction, a mode setting dial 1223 used to set a photographing mode, a cross button 1224 composed of an up arrow key, a down arrow key, a left arrow key, and a right arrow key, a menu button 1225 used to instruct on display of a menu, an execution button 1226 used to start executing a predetermined process, and a cancel button 1227 used to cancel the predetermined process.

When an operation for a print request is performed, the liquid crystal display 121 displays the number of printed sheets inputted using the cross button 1224, together with an image.

The camera 10 has an image pickup element that picks up an image of an object, an image processing device that processes picked-up images, and a well-known device such as a memory which temporarily stores the processed images (none of these components are shown). Consequently, images picked up by the camera 10 can be transferred to the storage 20a and then stored in the recording medium 21 installed in the storage 20a.

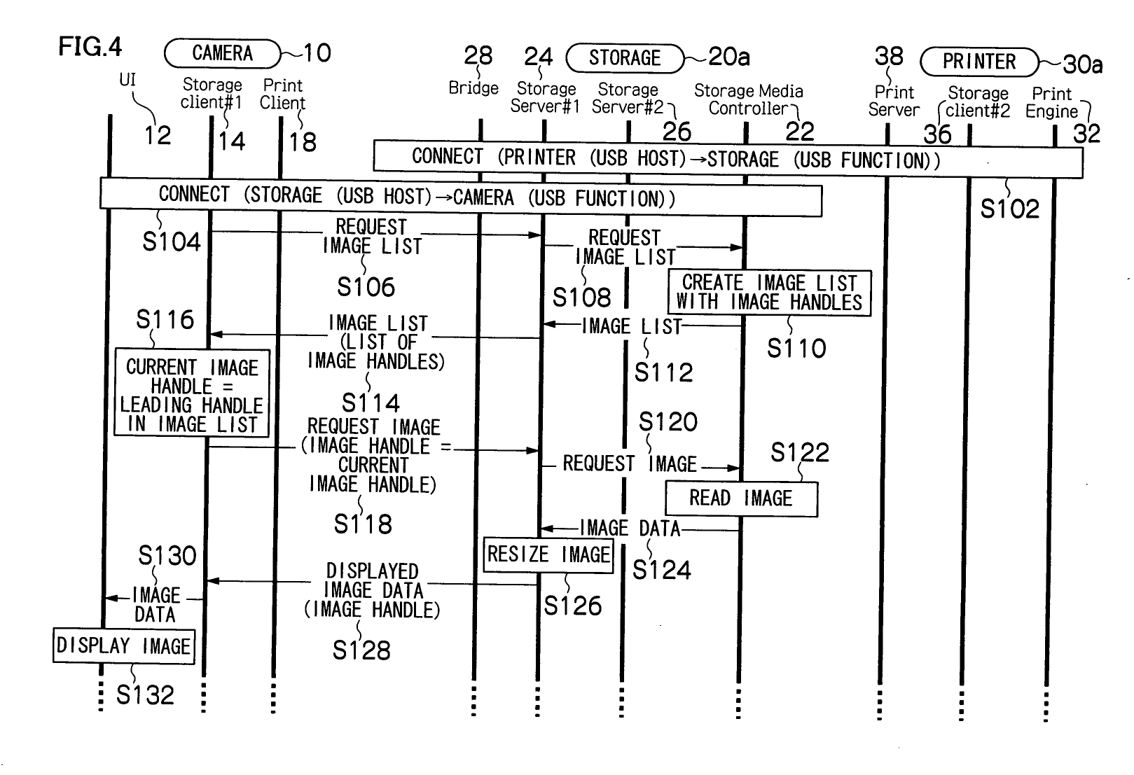

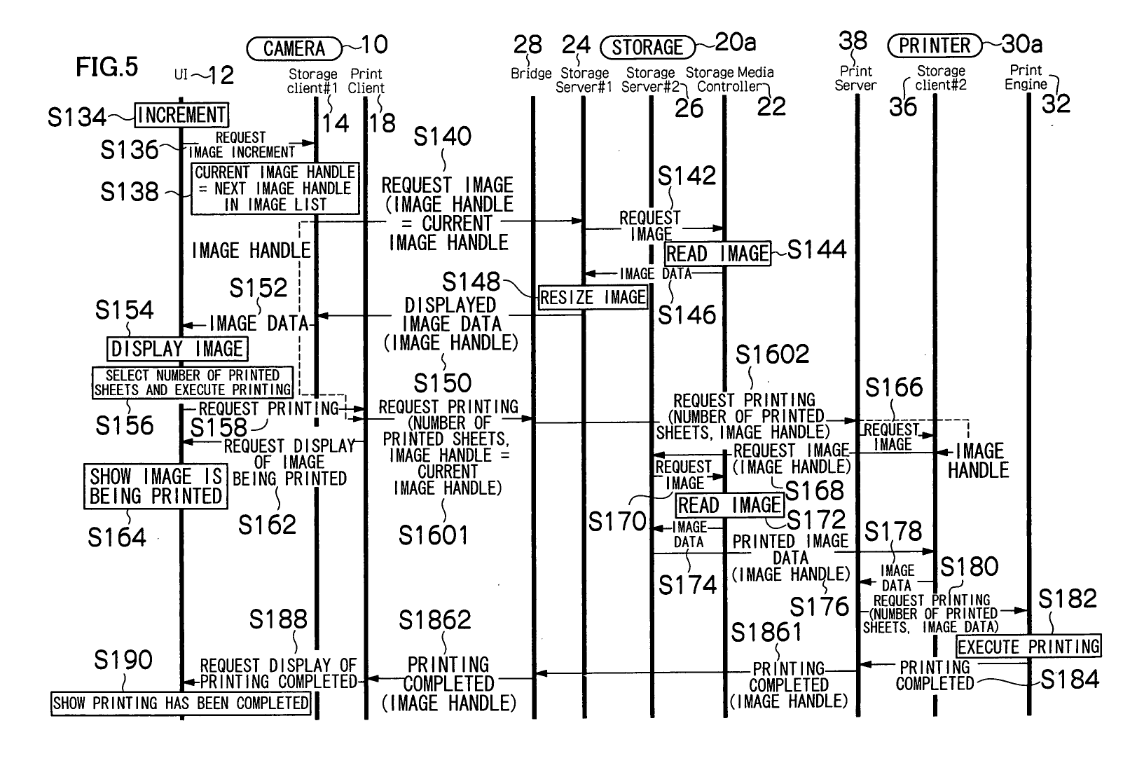

FIGS. 4 and 5 show the flow of communications in the print system according to the first embodiment.

In FIG. 4, the storage 20a and the printer 30a are connected together using the first USB cable 40 (S102). The storage 20a and the printer 30a are connected together so that the storage 20a acts as a function, while the printer 30a acts as a host. Moreover, the camera 10 and the storage 20a are connected together using the second USB cable 50 (S104). The camera 10 and the storage 20a are connected together so that the camera 10 acts as a function, while the storage 20a acts as a host.

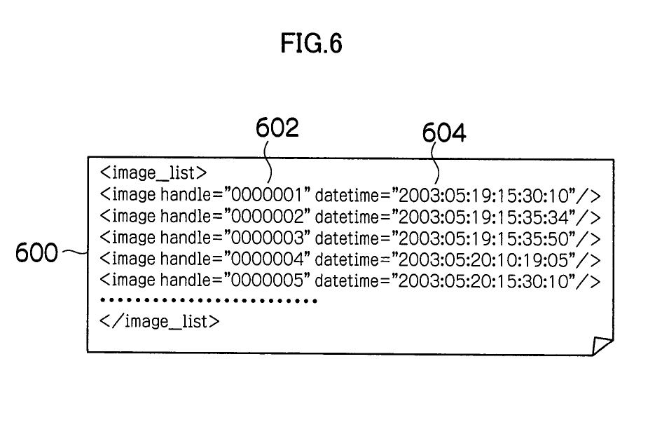

Once the connections are completed, the first storage client 14 of the camera 10 requests an image list of the first storage server 24 of the storage 20a (S106). The first storage server 24, of which the image list has been requested, further requests the image list of the recording medium controller 22 of the storage 20a (S108). The recording medium controller 22 generates an image list 600 such as the one shown in FIG. 6 (S110). The recording medium controller 22 generates the image list 600 by applying an image handle 602 to each of the image data in the recording medium 21 and providing information such as a photographed date and time 604. Upon receiving the image list from the recording medium controller 22 (S112), the first storage server 24 provides the image list to the first storage client 14 of the camera 10 (S114).

Upon acquiring the image list, the first storage client 14 of the camera 10 initializes the leading image handle of the image list (or the last image handle of the image list) to the current image handle (S116). The first storage client 14 then requests displayed image data corresponding to the current image handle, of the first storage server 24 of the storage 20a (S118). The first storage server 24, of which the displayed image data has been requested, requests the recording medium controller 22 of the storage 20a to read image data (S120). The recording medium controller 22 then reads the image data corresponding to the current image handle from the recording medium 21 (S122). Upon acquiring the image data from the recording medium controller 22 (S124), the first storage server 24 resizes the image data (changes the size to one corresponding to, for example, VGA or QVGA) to generate contracted images (displayed image data) to be displayed using the user interface 12 of the camera 10 (S126). The first storage server 24 then provides the displayed image data to the first storage client 14 of the camera 10 (S128). The displayed image data is delivered to the user interface 12 of the camera 10 (S130). Then, the image corresponding to the current image handle is displayed (S132).

In FIG. 5, if the user desires the next image (or preceding image) to be displayed, the user uses the cross button 1224 to perform an increment operation (or a decrement operation) (S134). A request for an image increment (or a request for an image decrement) is issued to the first storage client 14 of the camera 10 (S136). The first storage client 14 increments (or decrements) the current image handle (S138). The first storage client 14 then requests the displayed image data corresponding to the current image handle, of the first storage server 24 of the storage 20a (S140). The first storage server 24, of which the displayed image data has been requested, requests the recording medium controller 22 of the storage 20a to read image data (S142). The recording medium controller 22 then reads the image data corresponding to the current image handle from the recording medium 21 (S144). Upon acquiring the image data from the recording medium controller 22 (S146), the first storage server 24 resizes the image data to acquire the displayed image data (S148). The first storage server 24 then provides the displayed image data to the first storage client 14 of the camera 10 (S150). The displayed image data is delivered to the user interface 12 of the camera 10 (S152). Then, the image corresponding to the current image handle is displayed (S154).

If the user desires the displayed image to be printed, the user uses the cross button 1224 to input the number of printed sheets (for example, a default value is set at 1 and the up arrow key is used to increment the number of printed sheets, while the down arrow key is used to decrement the number of printed sheets). The user then depresses the execution button to instruct on execution of printing (S156). Then, a request for printing is issued to the print client 18 of the camera 10 (S158). The print client 18 uses, as arguments, the inputted number of printed sheets and the current image handle indicative of the image being displayed, to request the print server 38 of the printer 30a to execute printing (S1601, S1602). The print request is temporarily received by the bridge 28 of the storage 20a and transferred directly to the printer 30a. The print client 18 of the camera 10 requests the user interface 12 of the camera 10 to show that the image is being printed (S162). Thus, the display shows that the image is being printed (S164).

Upon receiving the print request, the print server 38 of the printer 30a uses the current image handle in the print request to request printed image data of the second storage client 36 of the printer 30a (S166). The second storage client 36 requests the printed image data corresponding to the current image handle, of the second storage server 26 of the storage 20a (S168). The recording medium controller 22 of the storage 20a is requested to read image data (S170). Then, the image corresponding to the current image handle is read from the recording medium 21 (S172). Upon receiving the image data from the recording medium controller 22 (S174), the second storage server 26 provides this image data to the storage client 36 of the printer 30a as printed image data (or resizes the data up to a sufficient size required for printing) (S176). The printed image data is then delivered to the print server 38 of the printer 30b (S178).

Then, the print server 38 uses the number of printed sheets and the printed image data as arguments to request the print engine 32 of the printer 30a to execute printing (S180). The print engine 32 then prints the set number of sheets (S182). Once the printing is completed, the print engine 32 notifies the print server 38 that the printing has been completed (S184). The print server 38 responds to the print client 18 of the camera 10 with the image handle to notify the print client 18 that the printing has been completed (S1861, S1862). The print completion notification is received by the bridge 28 of the storage 20a and then transferred directly to the camera 10. The print client 18 of the camera 10 requests the user interface 12 of the camera 10 to show that the printing has been completed (S188). Then, the display shows that the printing has been completed (S190).

According to the print system of the present embodiment, the camera 10 acquires the images in the recording medium 21, installed in the storage 20a, as well as the image identifiers (image handles) applied to the respective images, and the user uses the user interface 12 of the camera 10 to select the desired image to be printed. Then, the transfer device (bridge) 28 of the storage 20a transfers the print request containing the image identifier for the user's selected image, from the camera 10 directly to the printer 30a. Then, on the basis of the image identifier in the print request, the printer 30a can acquire the image to be printed, from the storage 20a, to print the user's desired image.

### Second Embodiment

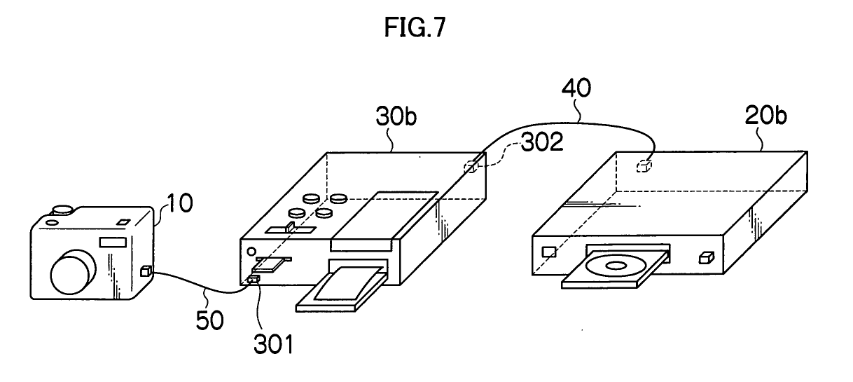

FIG. 7 is a schematic view of a print system according to a second embodiment of the present invention.

In the print system according to the second embodiment, a storage 20b and a printer 30b are connected using the first USB cable 40. Moreover, the camera 10 is connected to the printer 30b using a second USB cable 50. Here, the storage 20b and the printer 30b are connected together so that the storage 20b acts as a host, while the printer 30b acts as a function (client). The camera 10 and the printer 30b are connected together so that the camera 10 acts as a function (client), while the printer 30b acts as a host.

A connector 301 of the printer 30b is used to connect the printer 30b to the camera 10, which is a portable apparatus. The connector 301 is frequently inserted and removed by the user and is thus placed on the front surface of the body. On the other hand, a connector 302 is used to connect the printer 30b to the storage 20b, which is an installed apparatus. The connector 302 is not frequently inserted or removed by the user. Accordingly, the connector 302 is placed on the rear surface of the body so that the USB cable 40 does not obstruct operations.

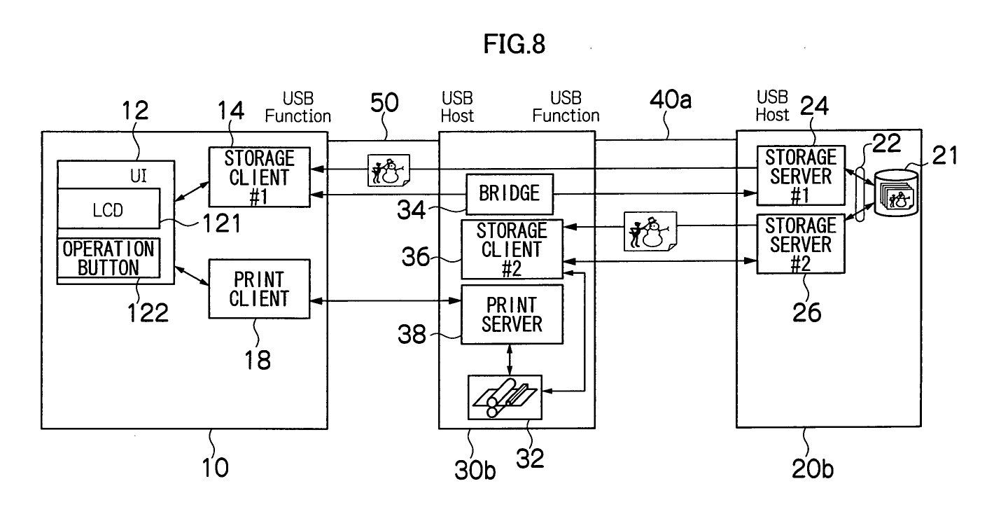

FIG. 8 is a block diagram showing the internal configuration of each of the camera 10, printer 30b, and storage 20b.

The camera 10 comprises the user interface 12 including the liquid crystal display (LCD) 121 and the various operation buttons 122, the first storage client 14 that acquires, from the storage 20b, images in the recording medium 21 and image handles (also called image identifiers) applied to the respective images, and the print client 18 that issues a print request containing the image handle corresponding to an image to be printed.

The printer 30b comprises the print server 38 that receives a print request, the second storage client 36 that acquires the image corresponding to the image handler in the print request, from the storage 20b, the print engine 32 that prints the image acquired from the storage 20b, and a bridge 34 that transfers a request from the camera 10 directly to the storage 20b and a response and an event notification from the storage 20b directly to the camera 10.

The storage 20b comprises the removable recording medium 21, the recording medium controller 22 that, for example, writes or reads images in or from the recording medium 21, the first storage server 24 that provides the camera 10 with the images in the recording medium 21 and the mage handles applied to the respective images, and the second storage server 26 that provides printed image data to the printer 30b on the basis of the image handle. The same recording medium controller 22 manages the image identifiers (image handles) for the images. Accordingly, the first storage server 24 and the second storage server 26 use the same image identifier for the same image.

The first storage client 14 of the camera 10 and the first storage server 24 of the storage 20a constitute a pair. Specifically, the first storage client 14 requests an image list, a list of the images recorded in the recording medium 21, of the first storage server 24. Then, in response, the first storage server 24 provides the image list to the first storage client 14. The image list contains image handles. Further, the first storage client 14 requests image data to be displayed on the user interface 12, of the first storage server 24. Then, in response, the first storage server 24 provides the first storage client 14 with the image data to be displayed. The first storage client 14 specifies the image data using the image handle.

Further, the second storage client 36 of the printer 30b and the second storage server 26 of the storage 20b constitute a pair. Specifically, the second storage client 36 requests image data to be printed by the print engine 32, of the second storage server 26. Then, in response, the second storage server 26 provides the first storage client 14 with the printed image data. The second storage client 36 specifies the image data using the image handle.

Further, the print client 18 of the camera 10 and the print server 38 of the printer 30b constitute a pair. Specifically, the print client 18 issues a print request to the print server 38. Then, in response, the print server 38 uses the print engine 32 to print image data in accordance with the print request from the print client 18. The print client 18 specifies the image data using the image handle.

The bridge 34 of the printer 30b transfers a request from the first storage client 14 of the camera 10 directly to the first storage server 24 of the storage 20b and a response and an event notification from the first storage server 24 of the storage 20bdirectly to the first storage client 14 of the camera 10.

The camera 10 has an image pickup element that picks up an image of an object, an image processing device that processes picked-up images, and a well-known device such as a memory which temporarily stores the processed images (none of these components are shown). Consequently, images picked up by the camera 10 can be transferred to the storage 20b and then stored in the recording medium 21 installed in the storage 20b.

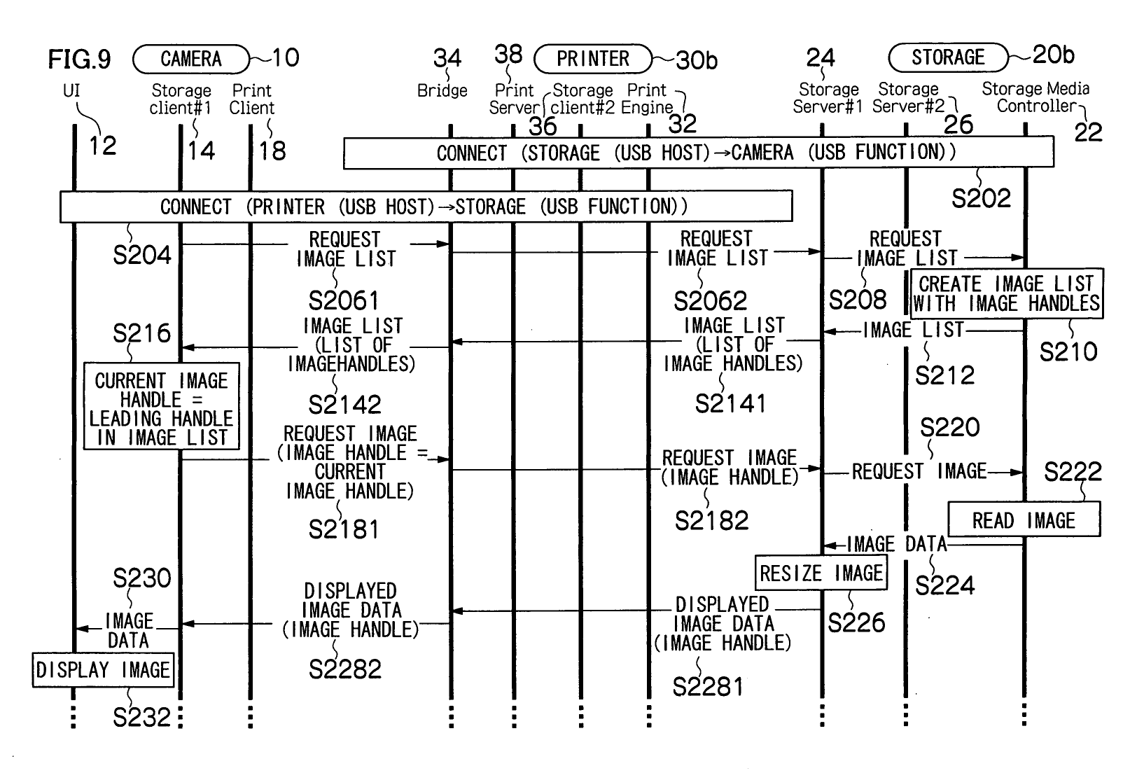

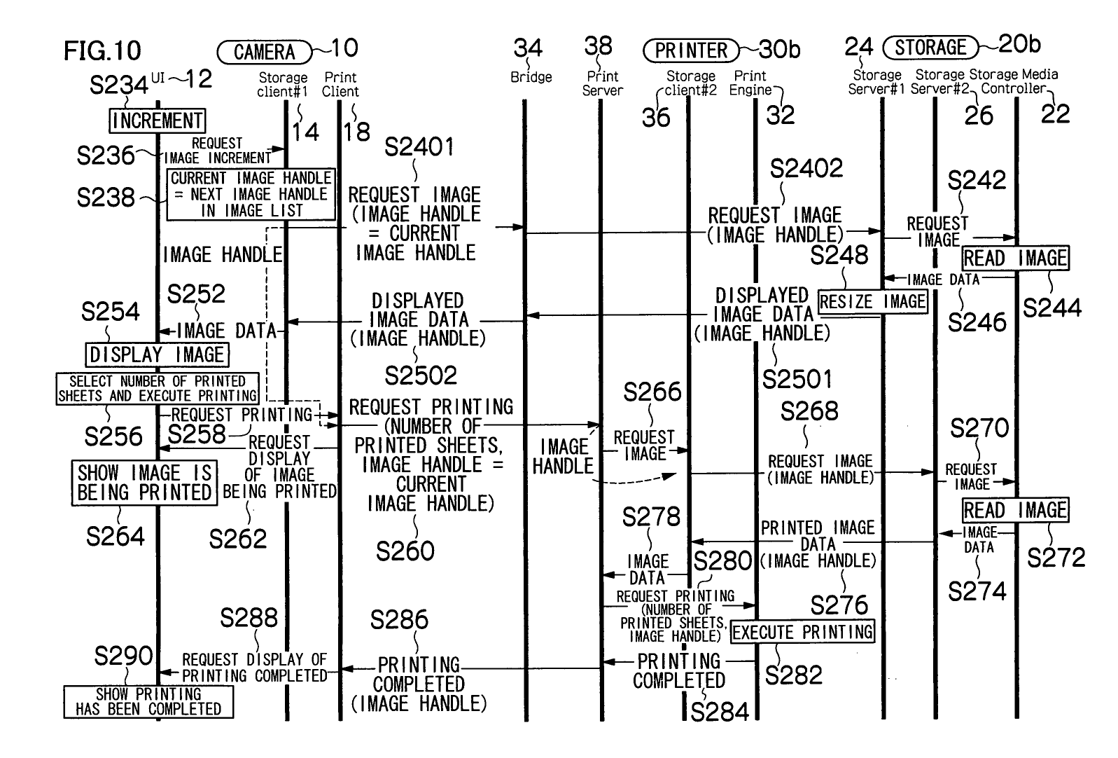

FIGS. 9 and 10 show the flow of communications in the print system according to the second embodiment.

In FIG. 9, the storage 20b and the printer 30b are connected together using the first USB cable 40 (S202). The storage 20b and the printer 30b are connected together so that the storage 20b acts as a host, while the printer 30b acts as a function. Moreover, the camera 10 and the printer 30b are connected together using the second USB cable 50 (S204). The camera 10 and the printer 30b are connected together so that the printer 30b acts as a host, while the camera 10 acts as a function.

Once the connections are completed, the first storage client 14 of the camera 10 requests an image list of the first storage server 24 of the storage 20b (S2061, S2062). Then, the request for an image list is temporarily received by the bridge 34 of the printer 30b and then transferred directly to the storage 20b. The first storage server 24, of which the image list has been requested, further requests the image list of the recording medium controller 22 of the storage 20b (S208). The recording medium controller 22 generates an image list 600 such as the one shown in FIG. 6 (S210). Upon receiving the image list from the recording medium controller 22 (S212), the first storage server 24 provides the image list to the first storage client 14 of the camera 10 (S2141, S2142). Then, the image list is temporarily received by the bridge 34 of the printer 30b and then transferred directly to the camera 10.

Upon acquiring the image list, the first storage client 14 of the camera 10 initializes the leading image handle of the image list (or the last image handle of the image list) to the current image handle (S216). The first storage client 14 then requests displayed image data corresponding to the current image handle, of the first storage server 24 of the storage 20b (S2181, S2182). Then, the request for displayed image data is temporarily received by the bridge 34 of the printer 30b and then transferred directly to the storage 20b. The first storage server 24, of which the displayed image data has been requested, requests the recording medium controller 22 of the storage 20a to read image data (S220). The recording medium controller 22 then reads the image data corresponding to the current image handle from the recording medium 21 (S222). Upon acquiring the image data from the recording medium controller 22 (S224), the first storage server 24 resizes the image data to generate contracted images (displayed image data) to be displayed using the user interface 12 of the camera 10 (S226). The first storage server 24 then provides the displayed image data to the first storage client 14 of the camera 10 (S2281, S2282). Then, the displayed image data is temporarily received by the bridge 34 of the printer 30b and then transferred directly to the camera 10. The displayed image data is delivered to the user interface 12 of the camera 10 (S230). Then, the image corresponding to the current image handle is displayed (S232).

In FIG. 10, if the user desires the next image (or preceding image) to be displayed, the user uses the cross button 1224 to perform an increment operation (or a decrement operation) (S234). A request for an image increment (or a request for an image decrement) is issued to the first storage client 14 of the camera 10 (S236). The first storage client 14 increments (or decrements) the current image handle (S238). The first storage client 14 then requests the displayed image data corresponding to the current image handle, of the first storage server 24 of the storage 20b (S2401, S2402). The first storage server 24, of which the displayed image data has been requested, requests the recording medium controller 22 of the storage 20b to read image data (S242). The recording medium controller 22 then reads the image data corresponding to the current image handle from the recording medium 21 (S244). Upon acquiring the image data from the recording medium controller 22 (S246), the first storage server 24 resizes the image data to acquire the displayed image data (S248). The first storage server 24 then provides the displayed image data to the first storage client 14 of the camera 10 (S2501, S2502). The displayed image data is delivered to the user interface 12 of the camera 10 (S252). Then, the image corresponding to the current image handle is displayed (S254).

If the user desires the displayed image to be printed, the user uses the cross button 1224 to input the number of printed sheets. The user then depresses the execution button to instruct on execution of printing (S256). Then, a request for printing is issued to the print client 18 of the camera 10 (S258). The print client 18 uses, as arguments, the inputted number of printed sheets and the current image handle indicative of the image being displayed, to request the print server 38 of the printer 30b to execute printing (S260). Further, the print client 18 of the camera 10 requests the user interface 12 of the camera 10 to show that the image is being printed (S262). Thus, the display shows that the image is being printed (S264).

Upon receiving the print request, the print server 38 of the printer 30b uses the current image handle in the print request to request printed image data of the second storage client 36 of the printer 30b (S266). The second storage client 36 requests the printed image data corresponding to the current image handle, of the second storage server 26 of the storage 20b (S268). The recording medium controller 22 of the storage 20b is requested to read image data (S270). Then, the image corresponding to the current image handle is read from the recording medium 21 (S272). Upon receiving the image data from the recording medium controller 22 (S274), the second storage server 26 provides this image data to the storage client 36 of the printer 30b as printed image data (S276). The printed image data is then delivered to the print server 38 of the printer (S278).

Then, the print server 38 uses the number of printed sheets and the printed image data as arguments to request the print engine 32 of the printer 30b to execute printing (S280). The print engine 32 then prints the set number of sheets (S282). Once the printing is completed, the print engine 32 notifies the print server 38 that the printing has been completed (S284). The print server 38 responds to the print client 18 of the camera 10 with the image handle to notify the print client 18 that the printing has been completed (S286). The print client 18 of the camera 10 requests the user interface 12 of the camera 10 to show that the printing has been completed (S288). Then, the display shows that the printing has been completed (S290).

According to the print system of the present embodiment, the transfer device (bridge) 34 of the printer 30b transfers a request from the camera 10 directly to the storage 20b and a response from the storage 20b directly to the camera 10, the camera 10 then acquires the images in the recording medium 21, installed in the storage 20b, as well as the image identifiers (image handles) applied to the respective images, and the user uses the user interface 12 of the camera 10 to select the desired image to be printed. Then, the print request containing the image identifier for the user's selected image is issued by the camera 10 to the printer 30b. Then, on the basis of the image identifier in the print request, the printer 30b can acquire the image to be printed, from the storage 20b, to print the user's desired image.

If the image file in the recording medium contains thumbnail images, the image to be displayed on the user interface 12 of the camera 10 may be the thumbnail images taken out of the image file.

Further, in the above described embodiments, the operation apparatus is a camera which displays images. However, the present invention is not limited to this aspect. The operation apparatus may be a cellular phone or any of other portable apparatuses which displays images.

1. A print system, comprising:
a printer;
a storage, being connected to said printer via a first connection path, which takes image out of a predetermined recording medium in which a plurality of images are recorded; and
an operation apparatus connected to said storage via a second communication path; wherein
said operation apparatus has:
a first storage client which acquires, from said storage, the images in said recording medium and image identifiers applied to the respective images;
a user interface which displays images and which selectively manipulates an image to be printed; and
a print client which issues a print request containing an image identifier corresponding to the image selected by said user interface,
said storage has:
a first storage server which provides said operation apparatus with the images in said recording medium and the image identifiers applied to the respective images;
a transfer device which transfers a print request from said operation apparatus directly to said printer; and
a second storage server which provides said printer with an image corresponding an image identifier in said print request,
said first storage server and said second storage server use the same image identifier for the same image, and
said printer has:
a printing device which receives said print request via the transfer device of said storage;
a second storage client which acquires an image corresponding to the image identifier in said print request, from said storage; and
a printing device which prints the image acquired from said storage.

2. A print system, comprising:
a printer;
a storage, being connected to said printer via a first connection path, which takes each image out of a predetermined recording medium in which a plurality of images are recorded; and
an operation apparatus connected to said storage via a second communication path, wherein
said operation apparatus has:
a first storage client which requests acquires, from said storage, the images in said recording medium and image identifiers applied to the respective images;
a user interface which displays images and which selectively manipulates an image to be printed; and
a print client which issues a print request containing an image identifier corresponding to the image selected by said user interface,
said storage has:
a first storage server which provides said operation apparatus with the images in said recording medium and the image identifiers applied to the respective images; and
a second storage server which provides said printer with an image corresponding an image identifier in said print request,
said first storage server and said second storage server use the same image identifier for the same image, and
said printer has:
a transfer device which directly transfers a request from said operation apparatus to said storage and a response from said storage to said operation apparatus;
a print server which receives a print request from said operation apparatus;
a second storage client which acquires an image corresponding to the image identifier in said print request, from said storage; and
a printing device which prints the image acquired from said storage.

3. The print system according to claim 1, wherein said first storage server provides said operation equipment with contracted images for display which are obtained by contracting the images recorded in said recording medium and which are displayed by the user interface of said operation equipment so that the contracted images are displayed by the user interface of said operation apparatus.

4. The print system according to claim 2, wherein said first storage server provides said operation equipment with contracted images for display which are obtained by contracting the images recorded in said recording medium and which are displayed by the user interface of said operation equipment so that the contracted images are displayed by the user interface of said operation apparatus.

5. A storage, comprising:
a first connector connected to an operation apparatus having a user interface which displays images and which selectively manipulates an image to be printed;
a second connector connected to a printer which prints images;
a first storage server which provides said operation apparatus, via said first connector, with the images in a predetermined recording medium in which a plurality of images are recorded and image identifiers applied to the respective images;
a transfer device which operates upon receiving a print request containing an image identifier corresponding to the image selected by said user interface of said operation apparatus via said first connector from said operation apparatus, to transfer the print request directly to said printer via said second connector; and
a second storage server which operates upon receiving an image request containing the image identifier in said print request, from said printer via said second connector, to provide said printer with an image corresponding the image identifier via said second connector, wherein
said first storage server and said second storage server use the same image identifier for the same image.

6. A printer, comprising:
a first connector connected to a storage that takes each image out of a predetermined recording medium in which a plurality of images are recorded;
a second connector connected to an operation apparatus having a user interface which displays images and which selectively manipulates an image to be printed;
a transfer device which operates upon receiving the images in said recording medium and image identifiers applied to the respective images, from said storage via said first connector, to transfer the image and image identifier directly to said operation apparatus via said second connector;
a print server which receives a print request containing an image identifier corresponding to the image selected by said user interface of said operation apparatus, from said operation apparatus via said second connector;
a storage client which acquires an image corresponding to the image identifier in said print request, from said storage via said first connector; and
a printing device which prints the image acquired from said storage.
